(19) United States
(12) Patent Application Publication
(10) Pub. No.: US 2023/0022789 A1
(43) Pub. Date: Jan. 26, 2023

(54) EFFICIENT UPDATES OF INFORMATION HANDLING SYSTEMS WITH LOCALIZED AGGREGATED TRANSFER AND STORAGE OF UPDATE PACKAGES

(71) Applicant: Dell Products L.P., Round Rock, TX (US)

(72) Inventors: Shelesh CHOPRA, Bangalore (IN); Hemant Ramesh GAIKWAD, Pune (IN); Rahul Deo VISHWAKARMA, Bangalore (IN)

(73) Assignee: Dell Products L.P., Round Rock, TX (US)

(21) Appl. No.: 17/384,705

(22) Filed: Jul. 23, 2021

(51) Int. Cl. G06F 8/65; H04L 12/751; G06F 9/50; H04L 12/24

(52) U.S. Cl. CPC G06F 8/65; H04L 45/02; G06F 9/5072; H04L 41/0893

(57) ABSTRACT

A method for managing information handling system updates includes identifying topological groups within a managed domain of information handling system devices and identifying one or more homogeneous subgroups, each of which corresponds to a single device type, within each of the identified topological groups. Device updates may then be performed for the managed domain based on the homogeneous subgroups. All instances of a particular device type within the managed domain are updated by performing subgroup-aware update operations that include transmitting a single update image for the particular device type to each topological group that includes a homogeneous subgroup corresponding to the particular device type. The single update image is then distributed to each instance of the particular device type within the topologic group.

### TECHNICAL FIELD

The present disclosure relates to information handling systems and, more specifically, firmware and other types of updates for information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Firmware updates for a server or storage device often require hundreds of megabytes of storage and large datacenters may include thousands of servers. It is also not uncommon for a datacenter to house multiple server and storage device models with different components, different operating system models, and different firmware update schedules. Accordingly, a datacenter administrator may need to dedicate multiple GBs of storage just for updates. If the administrator uses a system management appliance or application, the update storage space required would have to allocated either on the appliance or externally. Configuring a management appliance for additional storage and sequencing is generally not trivial and external storage carries an inherent risk of exposure or tampering. Moreover, every device update has to be downloaded to every instance of that device within the applicable domain, thereby consuming scarce and valuable network bandwidth.

### SUMMARY

Common problems associated with managing information handling system updates in large scale computing environments are addressed by disclosed management systems and methods. In accordance with subject matter disclosed in the following detailed description, a method for managing information handling system updates includes identifying topological groups within a managed domain of information handling system devices and identifying one or more homogeneous subgroups, each of which corresponds to a single device type, within each of the identified topological groups. Device updates may then be performed for the managed domain based on the homogeneous subgroups. All instances of a particular device type within the managed domain are updated by performing subgroup-aware update operations that include transmitting a single update image for the particular device type to each topological group that includes a homogeneous subgroup corresponding to the particular device type. The single update image is then distributed to each instance of the particular device type within the topologic group.

The devices to be updated include servers, storage devices, and other types of information handling resources. In at least one embodiment suitable for datacenter environments comprising a plurality of rack cabinets, each topological group is associated with a rack cabinet and each node corresponds to a the rack cabinets top of rack device.

Identifying the homogeneous subgroups may include clustering all devices within a topological group based on quantitative indicators of homogeneity determined for each of the devices within the topological group. The clustering process may include generating a dissimilarity matrix for the devices within the topological group. The dissimilarity matrix may be generated by calculating Gower distances amongst the devices based on categorical device inventory data. After the distance matrix is established, clustering may process based on divisive clustering techniques, agglomerative cluster techniques, or a combination of both.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system management network;

FIG. 2 illustrates a device update according to the prior art;

FIG. 3 illustrates a device update according to disclosed subject matter;

FIG. 4 illustrates a flow diagram of a method for managing device updates; and

FIG. 5 illustrates a flow diagram of a clustering process.

### DETAILED DESCRIPTION

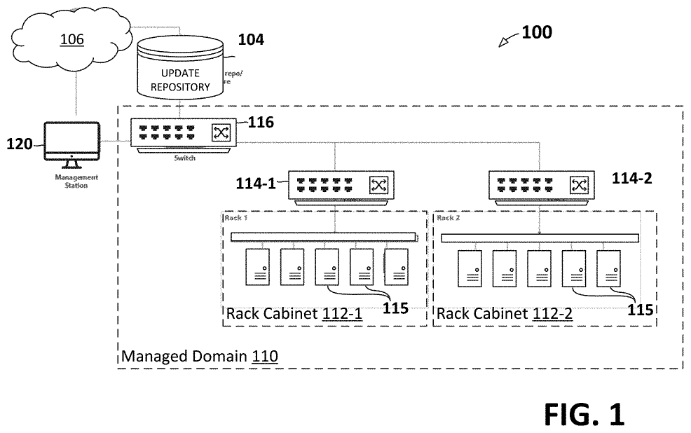

Exemplary embodiments and their advantages are best understood by reference to FIGS. 1-5, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates a management network 100 including a management station 120 configured to manage a plurality of information handling system devices 115. The manage station 120 is configured with access to a remote or cloud based update repository 104. Management station 120 receives devices updated from depository 104 when such updates are ready. Manager station 120 is coupled to a managed domain 110 and is configured with management responsibility for the information handling system devices 115.

In datacenter embodiments, the information handing system devices 115 are removable attached to rack cabinet structures or, more simply, rack cabinets 112. Each rack cabinet 112 illustrated in FIG. 1 is coupled to a top of rack device and each top of rack device 114 is couple to a network switch 116.

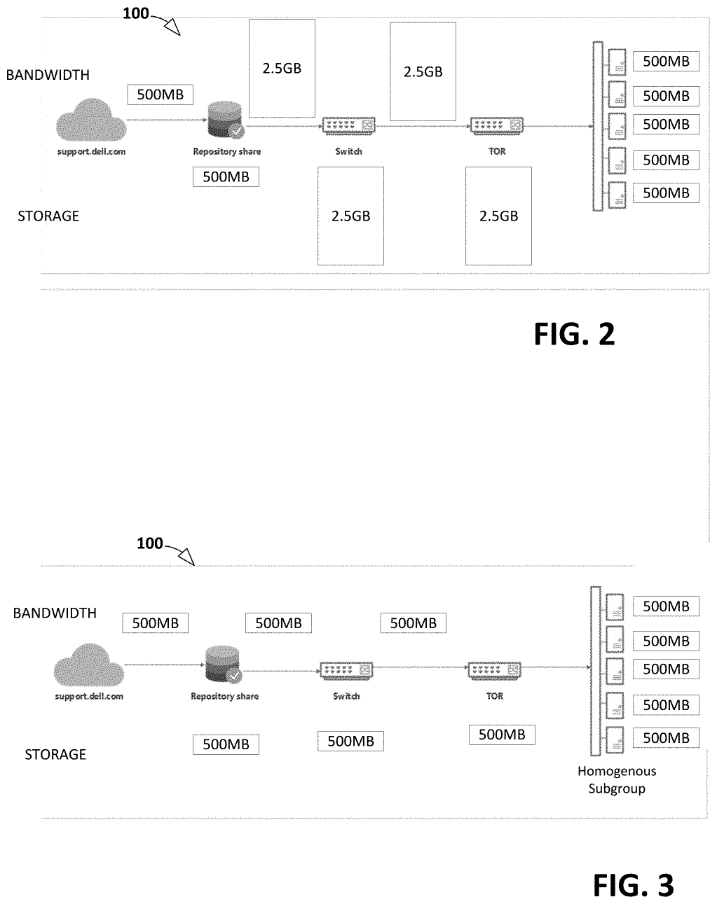

FIG. 2 and FIG. 3 illustrate distinctions between conventional device updates and device updates performed in accordance with disclosed subject matter. As illustrated in the conventional update process of FIG. 2, a 500 MB update of five endpoint devices includes an initial data transfer of 500 MB from the cloud based resources to the repository share. Thereafter, a datacenter resource determines that the device update is applicable to five endpoint devices connected to a particular rack server. The update illustrated in FIG. 2 then sends 5×500 MB or 2.5 GB, corresponding to five instances of the 500 MB update image, to the depository share, where the 2.5 GB of updates may be stored before being forwarded on to the top of rack device for the rack cabinet in which the five endpoint devices are attached.

The update process illustrated in FIG. 3 sends a single instance of the 500 MB update all the way from the repository share to the top of rack device, where the update may be stored pending delivery of the update to each of the applicable endpoint devices. Those of ordinary skill in the field of network computing and system management will appreciate that the update process illustrated in FIG. 3 offers a potentially significant reduction in the amount storage and bandwidth required to perform an update.

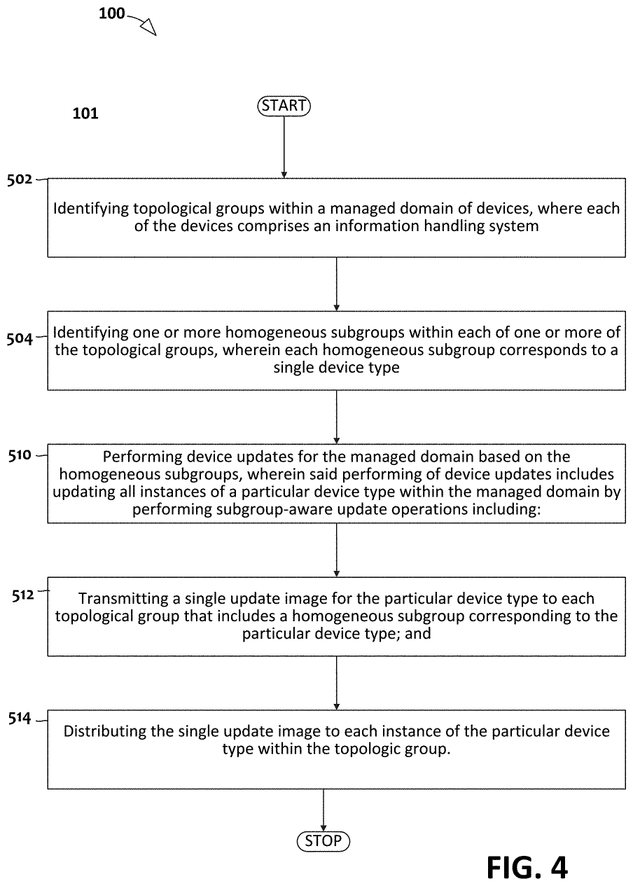

Referring now to FIG. 4, a method 400 for managing information handling system updates is illustrated in flow diagram format. The illustrated method, which may be performed by a management server such as the management server 120 (FIG. 1) referenced above, includes identifying (step 402) topological groups within a managed domain of information handling system devices.

Each topological group may correspond to a node of the domain or network managed by management server 120. In datacenter environments implemented with a plurality of rack cabinets, there may be a 1:1 correspondence between topological groups and rack cabinets such that each topological group may comprise all devices located within the applicable rack cabinet. In at least one such embodiment, some or all of the rack cabinets include a top of rack device coupled to the management server via the network switch 116 illustrated in FIG. 1.

One or more homogeneous subgroups may then be identified (step 404) within each topological group where each homogeneous subgroup corresponds to a single device type. Device updates may then be performed for the managed domain based on the homogeneous subgroups. Specifically, in at least one embodiment, all instances of a particular device type within the managed domain are updated by performing subgroup-aware update operations that include transmitting a single update image for the particular device type to each topological group that includes a homogeneous subgroup corresponding to the particular device type. The single update image may then be distributed to each instance of the particular device type within the topologic group.

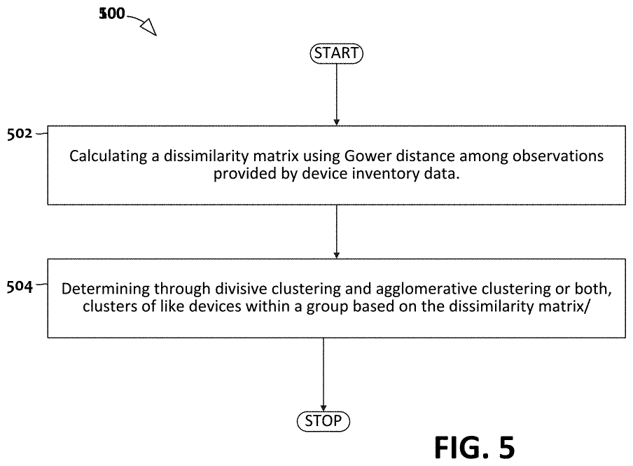

Referring to FIG. 5 a method 500 of identifying the homogenous subgroups within each topological group is illustrated. The illustrated method calculates (step 502) a dissimilarity matrix using Gower distance among observations provided by device inventory data. The dissimilarity matrix may then be used to determine (step 504), through divisive clustering, agglomerative clustering, or a combination of both, clusters of like devices within a group. Divisive clustering uses a top-down approach, while agglomerative uses a bottom-up approach. Using both techniques may be advantageous because agglomerative clustering is better in discovering small clusters while divisive clustering is better in discovering larger clusters.

The assessment of clustering techniques is based on evaluations of compactness and separation. In the experiments performed with actual device inventory data, agglomerative clustering was a more effective and efficient tool for identifying clusters.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An information handling system management method, comprising:
identifying topological groups within a managed domain of devices, where each of the devices comprises an information handling system;
identifying one or more homogeneous subgroups within each of one or more of the topological groups, wherein each homogeneous subgroup corresponds to a single device type; and
performing device updates for the managed domain based on the homogeneous subgroups, wherein said performing of device updates includes updating all instances of a particular device type within the managed domain by performing subgroup-aware update operations including:
transmitting a single update image for the particular device type to each topological group that includes a homogeneous subgroup corresponding to the particular device type; and
distributing the single update image to each instance of the particular device type within the topologic group.

2. The method of claim 1, wherein the devices comprise devices selected from server devices and storage devices.

3. The method of claim 1, wherein each topological group is associated with a corresponding node within the managed domain.

4. The method of claim 3, wherein the managed domain comprises a data center and wherein each of the nodes is associated with a corresponding rack cabinet of the data center.

5. The method of claim 4, wherein each rack cabinet includes a top of rack device and wherein each topological group node corresponds to the top of rack device of the corresponding rack cabinet.

6. The method of claim 1, wherein identifying the homogeneous subgroups comprises clustering all devices within a topological group based on quantitative indicators of homogeneity determined for each of the devices with the topological group.

7. The method of claim 6, wherein said clustering includes generating a dissimilarity matrix for the devices within the topological group.

8. The method of claim 7, wherein the dissimilarity matrix is generated by calculating Gower distances amongst the devices based on categorical device inventory data.

9. The method of claim 7, wherein said clustering further includes divisive clustering of the dissimilarity matrix.

10. The method of claim 7, wherein said clustering further includes agglomerative clustering of the dissimilarity matrix.

11. An information handling system, comprising:
a central processing unit (CPU);
system memory, accessible to the CPU, including computer executable instructions that, when executed by the CPU, cause the system to perform system management operations, comprising:
identifying topological groups within a managed domain of devices, where each of the devices comprises an information handling system;
identifying one or more homogeneous subgroups within each of one or more of the topological groups, wherein each homogeneous subgroup corresponds to a single device type; and
performing device updates for the managed domain based on the homogeneous subgroups, wherein said performing of device updates includes updating all instances of a particular device type within the managed domain by performing subgroup-aware update operations including:
transmitting a single update image for the particular device type to each topological group that includes a homogeneous subgroup corresponding to the particular device type; and
distributing the single update image to each instance of the particular device type within the topologic group.

12. The information handling system of claim 11, wherein the devices comprise devices selected from server devices and storage devices.

13. The information handling system of claim 11, wherein each topological group is associated with a corresponding node within the managed domain.

14. The information handling system of claim 13, wherein the managed domain comprises a data center and wherein each of the nodes is associated with a corresponding rack cabinet of the data center.

15. The information handling system of claim 14, wherein each rack cabinet includes a top of rack device and wherein each topological group node corresponds to the top of rack device of the corresponding rack cabinet.

16. The information handling system of claim 11, wherein identifying the homogeneous subgroups comprises clustering all devices within a topological group based on quantitative indicators of homogeneity determined for each of the devices with the topological group.

17. The information handling system of claim 16, wherein said clustering includes generating a dissimilarity matrix for the devices within the topological group.

18. The information handling system of claim 17, wherein the dissimilarity matrix is generated by calculating Gower distances amongst the devices based on categorical device inventory data.

19. The information handling system of claim 16, wherein said clustering further includes divisive clustering of the dissimilarity matrix.

20. The information handling system of claim 16, wherein said clustering further includes agglomerative clustering of the dissimilarity matrix.
